(19) United States
(12) Patent Application Publication
(10) Pub. No.: US 2022/0220773 A1
(43) Pub. Date: Jul. 14, 2022

(54) An Electric Lock

(71) Applicant: Clint BARRETT, Wickford, Essex (GB)

(72) Inventor: Clint BARRETT, Wickford, Essex (GB)

(21) Appl. No.: 17/614,544

(22) PCT Filed: Jun. 18, 2019
(86) PCT No.: PCT/IB20/55687

§ 371 Date: Nov. 28, 2021

(30) Foreign Application Priority Data
Jun. 18, 2019 (GB) 1908713.9

(51) Int. Cl. E05B 39/00; E05B 71/00; B62H 5/20; H04N 7/18; H04W 4/021

(52) U.S. Cl. CPC E05B 39/005; E05B 71/00; H04W 4/021; B62H 5/20; H04N 7/188; E05B 39/007

(57) ABSTRACT

The present invention relates to electric lock.

The electric lock has a housing with a lockable clamp for securing the housing to a cycle that is adapted to receive part of a cycle frame. A tethering connector extends from the housing having first and second ends; the second end of the tethering connector is fixed to the housing and the first end of the tethering connector is secured to the housing by a lock.

An alert means is provided in/on the housing. The tethering connector and the housing define an electrical circuit which is operative to trigger the alert means when the circuit is broken.

### FIELD OF THE INVENTION

The present invention relates to an electric lock. More particularly, but not exclusively, the invention relates to a lock for a cycle (or bicycle), a motorcycle or similar vehicle. More particularly the invention relates to a lock that includes an electric continuity circuit which when broken triggers an alarm.

### BACKGROUND

Increasing numbers of people enjoy cycling, as roads become more congested and health benefits are recognised.

Many such users tend to be urban based and digitally aware who also spend significant sums on cycles, as well as on other high value electronic equipment such as smartphones.

In such cases it can be worrying to leave their cycle unattended, and it may be recognised as problematic. A solution may be to allow the user an alert means, which may be local and/or related to their smartphone or other electronic equipment. In this way the user may be alerted and made to feel more comfortable about leaving their cycle unattended.

### PRIOR ART

U.S. Pat. No. 9,260,885 (ASQUITH et al) discloses various technologies which relate to detection of a lock is being tampered with, cut or removed.

GB 2 508 896 (AL-ANAZI) discloses a portable lock comprising an elongate member, a housing arranged in use to receive the first and second ends of the elongate member and a lock mechanism to lock said ends in a locked position.

U.S. Pat. No. 7,543,467 (SHEEHAN) discloses a portable locking device having a wireless transmitter that transmits the condition of the locking device to the receiver of a security system.

The invention arose in order to overcome problems encountered in existing cycle locks.

### SUMMARY OF THE INVENTION

According to the present invention there is provided an electric lock comprising a housing with a lockable clamp that secures the housing to a frame of a cycle, the housing receives and locks at least one of a first and a second end of a tethering connector, the tethering connector has a conductive portion so that when the two ends are locked with respect to the housing, a circuit is completed which receives electric current from a source; a sensor detects continuity in the circuit; and an alert means is operative under control of a processor to trigger an alarm when an unauthorised break of continuity is detected.

Preferably the lock is adapted for use on a bicycle or motorcycle, or other similar type vehicle such as a scooter or ‘quad bike’. It is appreciated that the term cycle includes both bicycles and motorcycles and for the purposes of this application reference to a cycle is interchangeable with terms for other terms, such a bicycle, motorcycle, moped scooter, push along scooter, motorised push along scooter and ‘quad bike’, as well as similar modes of transport.

The electric lock provides at least two locking mechanisms. The electric lock is locked to the cycle by means of the lockable clamp on the housing (first locking mechanism) and when in use, the electric lock is locked about an object by the tethering connector (second locking mechanism). In this way the cycle, or other vehicle type, is more securely locked than has previously been the case, as although the tethering connector may be cut, the housing cannot be easily removed from the frame and therefore the alert means is not removed from the cycle by cutting the tethering connector. This thereby overcomes a common failing with many traditional cycle locks.

Preferably each locking mechanism is independent of another and thereby improves security. For example, the lockable clamp may require a conventional key and/or a code to be input and/or a release signal from a mobile device, in order to unlock the clamp from a frame of the cycle. The lock associated with the tethered connector may have a different key and/or require a different code to be input and/or a need a release signal from a mobile device.

Optionally the same key, code or release signal can be selected so that it unlocks the tethering connector from the housing as well as releasing the housing from the frame.

This type of lock is therefore a greater deterrent as although the cycle may be detached from the object, the housing that houses the alert means cannot be removed and therefore the alert means is fixed to the cycle, thereby helping to locate a stolen cycle as well as identify the thief.

The housing has a lockable clamp that is preferably adapted to receive and surround part of the cycle frame. In some embodiments the clamp may be arranged to clamp onto a down tube, or seat stay of a bicycle frame. Or for example, another cylindrical or tubular part of the cycle frame. The clamp is therefore adapted to fit to parts of the cycle, such as the frame, that are part of the frame and so cannot be removed.

In preferred embodiments the lockable clamp may include inserts to assist with securing fitting the clamp to the cycle, to prevent slippage in use and to protect the cycle. The inserts may be moulded portions, or a resiliently deformable layer.

In some embodiments the inserts may be arranged to project from the clamp to engage with the cycle frame.

In yet a further embodiment the projections may be moveable, so that they can be extended from, or retracted into, the housing. For example, a key lock for locking the clamp to the cycle, may be connected to the inserts, such that as the key is turned the inserts move. In this way turning the key may both lock the clamp to the cycle and project the inserts so that they engage with the cycle. It is appreciated that further rotations of the key may further extend the inserts.

The tethering connector includes a conductive portion such as a wire, a wire rope, a conductive chain or similar that is covered by a non-conductive material, so as to permit a current to pass through the tethering connector. In this way the tethering connector, in combination with the lock within the housing and a source of current, forms an electrical circuit when both ends of the tethering connector are connected to the lock in the housing.

Preferably the tethering connector is at least 1.6 metres long and ideally at least 1.8 metres long. In this way the tethering connector can be arranged to wrap around different parts of the cycle and an object. For example the tethering connector may be passed around a bicycle frame and through both wheels and around an object so that it is not possible for part of the bicycle, such as the wheels to be taken.

Ideally the tethering connector has a thickness of at least 10 mm and ideally at least 12 mm.

The lock includes a terminal to which both ends of the tethering connector connect thereby forming a continuity circuit. The terminal is combined with the lock in such a way so that connection of the two ends of the tethering connector to the lock, closes the circuit.

In a preferred embodiment a second end of the of the tethering connector is permanently fixed to the terminal of the lock that is located within the housing and the first end of the tethering connector is free and adapted to connect to a lock in the housing. Connection of the free first end of the tethering connector to the terminal associated with the lock closes the circuit.

Preferably the tethering connector is toughened to make it as difficult as possible to be cut through. Optionally the tethering connector may comprise several layers, as well as a sleeve to resists sawing and a waterproof outer casing or cover.

In some preferred embodiments the housing includes at least one battery as the source to create the electrified circuit and to power other features of the electric lock. Ideally the at least one battery is rechargeable, and a port may be provided for charging the at least one battery, for example a universal serial bus (USB) may be provided to charge the at least one battery.

In other embodiments the electric lock may be connected to a battery provided on the cycle. For example, the electric lock may be connected to an electric or e-bike or motorcycle battery.

The alert means may include visual alerts such as one or more light, audible alerts, such as a loudspeaker generating an alarm, haptic alerts, such as a vibration module or location alerts. In some embodiments a combination of alerts may be used.

For example, in some embodiments the alert means comprises a visual alert means, for example one or more light emitting diodes (LEDs) or other similar light source. The lights may be operated in sequence of flash to provide a strong visible alert.

In some such embodiments the light source or light sources may be operable independently, for a separate use, so as to provide lighting for a user to view the locks in low lighting situations and to assist with connection of the ends of the tethering connector to the lock.

In preferred embodiments the electric lock is adapted to communicate wirelessly with at least one remote electronic device.

A wireless communication means, in the housing, is enabled by the at least one processor which controls at least one transmitter for transmitting a signal to a remote device (a first remote controller). Optionally a receiver is also provided in the housing to receive signals sent by a remote transmitter.

Ideally the communication means (transmitter or transmitter and receiver), are located securely within the housing and are protected to avoid vandalism or attempts to disable them.

The communication means can be used to send a signal to one or more remote electronic device, such as a smartphone to indicate when an alert is triggered so that a user is aware of a potential theft of their cycle. In this way the status of the electric lock can be monitored and controlled remotely.

Optionally the remote controller is operative to transmit a signal to the electric lock in order to configure the lock to a user defined status.

The communication means may also be configured to transmit a status signal indicating the status of the electric lock to the remote electronic device, such as a smartphone. For example, the status signal can be transmitted at regular intervals, or transmitted upon request, from the transmitter in the housing of the electric lock, in order to confirm that the cycle has not be moved or tampered with and is still in its secured state. The status signal may also indicate that the electric lock is properly ‘armed’.

The electric lock can operate in an armed status in which an alert is triggered if the circuit is broken or disrupted, and an unarmed status in which activation of the alerts is not dependent on the circuit.

The alert means of the electric lock can be armed only when the continuity circuit is formed, so that if the circuit is broken or damage is detected by the at least one sensor, such as due to tampering with the tethering connector, the alert means are activated.

The electric lock may automatically be armed on forming the circuit, or the electric lock may be armed upon receipt of a command signal from a remote device.

Likewise, the electric lock may be unarmed when the circuit is broken by unlocking the lock using the key, code or authorisation signal, or the electric lock may be unarmed upon receipt of a command signal from a remote device.

In this way a signal transmitted from the electric lock may confirm if the cycle has been locked to an object and the electric lock status is ‘armed’ so that the alert will activate if the tethering connector is cut, or whether the electric lock is not in use and thus the status is ‘unarmed’ so the alert will not activate.

Furthermore the communication means may permit the operational status of the electric lock to be changed by sending a signal from a remote device to the electric lock. For example to arm the electric lock.

The status signal thereby reassures the user that the alert means will activate if the tethered connector is cut. Likewise the status signal may include an indication that a battery level is low, so warning the user that the electric lock may not be activated. The status signal may also indicate that the lock is not in use and thus is ‘unarmed’ so the alert means cannot activate.

Furthermore the communication means, when receiving a command signal, enables an operational status of the electric lock to be changed. Thus by sending a signal from a remote device to the electric lock a user is able to reconfigure an alarm status remotely and so, for example, arm the electric lock or select one or more alert means.

It is appreciated that the remote transmitter may be included in a portable electronic communication device, such as a smartphone, tablet or computer which has a transmitter and is operating using application specific software, such as an APP, intended for use with the electric lock, so that the electric lock can be easily controlled and monitored.

Signals are sent via a wireless network, for example using a (3G, 4G or 5G) mobile telephone network, a wireless local area network (wireless LAN) or a Wi-Fi network. Signals can be transmitted using a Bluetooth® protocol or a similar short range wireless protocol via an alternative radio frequency. It is appreciated that different wireless networks may be used to maintain connectively. For example Bluetooth® may be used for close proximity communications and a mobile telephone network may be used when the Bluetooth proximity range is exceeded.

In preferred embodiments the electric lock has a means for detecting location, such as a global positioning system (GPS). In this way the geo-location of the cycle can be identified at any time and a user may be alerted of location even when not local to their cycle, and even where no one is around to monitor local alerts, or thefts in general. The geo-location means provides a further, alternative alert means. Ideally the location means is contained within the housing so that it is protected and cannot be tampered with.

Preferably the means for detecting the location of the cycle may only be activated when the alert is triggered. For example, the means for detecting location may transmit a location beacon every few seconds so that location of the cycle can be easily tracked remotely.

In some embodiments a user can request location data, even when the alert is not active. For example, a user may request location data to remind a user of the location of their cycle.

The GPS may also provide an alternative geo-fence alert means. That is to say a geo-fence may be specified by the user. A geo-fence is an imaginary, invisible boundary that is defined by a specified distance from a geolocation. For example, a user may specify a 10 m geo-fence from the location where their cycle is left in a secured tethered state. In the event that a thief severs the tether, the alarm is triggered. If the cycle is removed beyond the geo-fence, an alert is transmitted to the remote receiver which is in the possession of the owner or, as mentioned above, the owner's parents or another appointed person.

Ideally the geo-location (GPS) means is contained within the housing so that it is protected and cannot be tampered with.

In a preferred embodiment the alert may include an anti-nuisance function that ceases or changes an audible or visual alert if the cycle is stationary for a pre-set period of time, for example for more than 20 seconds.

The stationary status may be determined by a movement sensor or by the location means. In this way if the stolen cycle is assumed as abandoned, as there has been no movement for a pre-set period of time, the alert will cause minimal disruption to nearby persons until the owner arrives to deactivate the alert and retrieve their bicycle. For example, an audible alarm may stop, or the volume and/or frequency may be reduced.

As a security measure when operating in anti-nuisance function, as soon as movement is detected, the standard alert will sound, until the user or an authorised user has disarmed the alert, either remotely or by disarming it in situ.

In another embodiment the housing may house at least one imaging means, such as a digital camera, to record photographic images or video. The at least one imaging means may be activated when the alert is triggered so as to help record location and details of the perpetrator. For example photographic images may be taken every 10 seconds, or 10 seconds of video may be recorded every minute.

It is appreciated that more than one camera may be provided in order to obtain images from different views. For example a front, rear, left and right imaging means may be provided on the housing.

Preferably any image data is automatically transferred to the remote device or selected devices so that the authorised user receives this information.

In this way images or video can be viewed on the remote device. For example an APP on the smartphone may enable a user to activate the camera and view live video.

The presence of at least one camera serves as an additional deterrent to a potential thief.

In some embodiments the imager (camera) may also be active when no alert is activated. For example if movement is detected, such as potential damage, or on demand, for example for a user to check the weather at the cycle's location.

Application specific software or an APP may be programmable, by way of a user specified menu, to enable a user to include other authorised users who are to be notified if a theft event is identified. For example, a child's parents may receive a notification that their child's cycle is being compromised or stolen; and data, such as images if the alert is activated.

In some embodiments the electric lock may include a memory to store data, such as images. In this way data may be exchanged when a user is in close proximity to help conserve the battery(ies) of the electric lock.

Some embodiments of the electric lock may include a personal alarm which may be mounted to or carried by the user. Preferably the personal alarm is a wireless enabled theft detection and notification apparatus which is operable with the electric lock.

The personal alarm is a second remote controller for the electric lock (in addition to the remote electronic device such as a smartphone). The personal alarm includes a button which when pressed can activate the alert of the electric lock. Upon activation a wireless signal is transmitted from the personal alarm to the electric lock. In this way the alert can be manually activated remotely.

For example if a cycle is taken when not secured to something, the user can sound the alarm on the bicycle. If the theft event has been observed the alert may be activated when the thief, or thieves are a safe distance away. This sudden activation of the alert after the theft has taken place would prompt the thief/thieves to leave the bicycle where they are so it can be retrieved when it is safe to do so.

Preferably the personal alarm is adapted to be worn or carried by a user, for example it may be clipped to a waistband, pocket or belt, in the form of a wristband or as a key chain such as a fob.

In preferred embodiments the personal alarm has a second function of sending a notification to a remote electronic device such as a smartphone, tablet or computer. In this way if a user, in particular a child, teenager or vulnerable adult feels threatened in a situation they can discreetly press a second button and a notification is sent to designated contacts notifying that the user requires assistance.

Preferably the personal alarm includes a location means so that location details, such as a map, may be sent with the notification.

In some embodiments the personal alarm may have a third function of activating a local alarm. For example, a third button may be provided for a user to press if in imminent danger. Therefore the personal alarm may include a loudspeaker to emit a loud sound when activated. In this way the personal alarm can also be used independently of the electric lock as a separate security and safety device. This can provide peace of mind to friends, family and carers.

It is appreciated that the APP may be configured to permit more than one authorised user, for example for a family, or an organisation that hires bicycles to be able to control the electric lock or personal alarms.

The authorised contacts can use the computer implement software (APP) on their own devices, which may include alert status and location.

It may be envisaged that in use authorised contacts are also permitted to communicate between themselves on via the APP, for example to help plan recovery logistics if assistance is required. The contact persons(s) are then able to assist the user and know their location. The APP can provide directions and estimated time of arrival.

It is also appreciated that different users may require different functionality. For example a primary user (such as the cycle owner, a parent, carer, or hire company owner) may be able to override alerts, whereas a secondary user (such as a person borrowing a cycle, child, vulnerable person or person hiring a cycle) may not require this level of functionality.

In yet a further embodiment the electric lock may be provided with one or more security module that is fitted to removable parts of the cycle, for example to the wheels. The security modules are configured to communicate with the electric lock and/or the remote device so that if a part of the cycle with a security module is removed, or separated a pre-set distance from the electric lock, an alert is triggered and/or geo-tracking is commenced, and/or image data is collected.

Ideally each security module has a locking means for connecting to a cycle, a wireless communication means, at least one sensor to monitor movement or proximity and an alarm.

In some embodiments the security module may also include a location tracker.

In this way each security module can detect if a part of the cycle is displaced by means of the at least one sensor or location tracker, which can activate the alarm and optionally transmit a signal to remote electronic device to alert a user.

A preferred embodiment of the invention will now be described by way of example only and with reference to the Figures in which:

### BRIEF DESCRIPTION OF FIGURES

FIG. 1 shows an isometric view of an embodiment of the device according to the present invention;

FIG. 2 shows a reverse isometric view of the embodiment of the device shown in FIG. 1;

FIG. 3 shows an exploded isometric view of the embodiment of the device shown in FIG. 1;

FIG. 4 shows a reverse exploded isometric view of the embodiment of the device shown in FIG. 1;

FIG. 5A shows a diagrammatical overview of an embodiment of the bicycle lock; and

FIG. 5B shows a diagrammatical overview of a system including the bicycle lock.

### DETAILED DESCRIPTION OF FIGURES

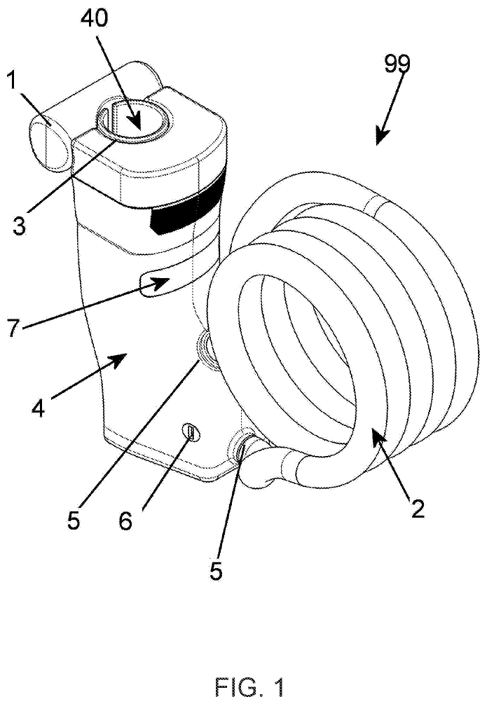

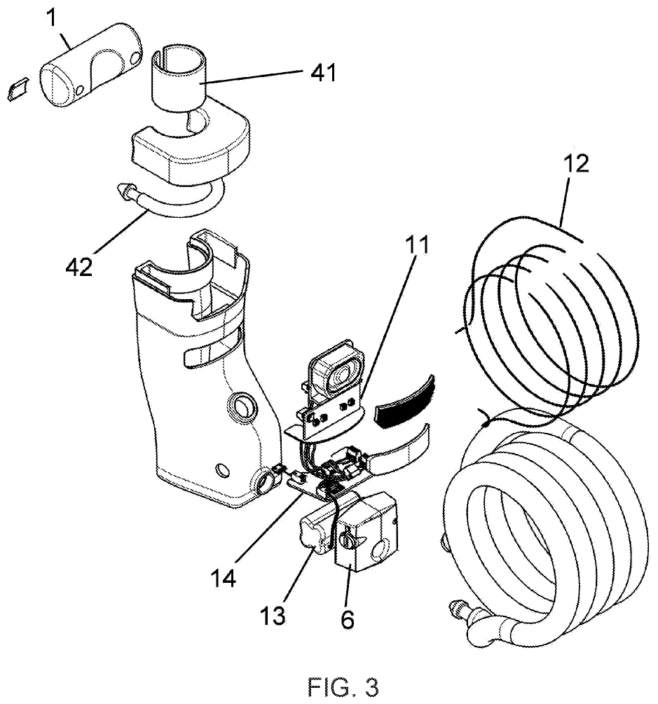

With reference to FIGS. 1 to 5 there is shown one preferred embodiment of the electric lock 99, comprising a tethering connector 2 extending from a housing 4.

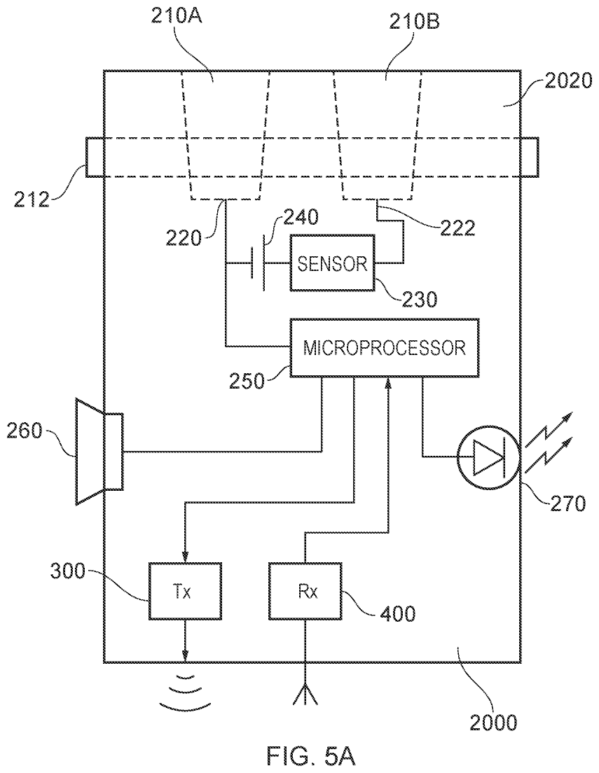

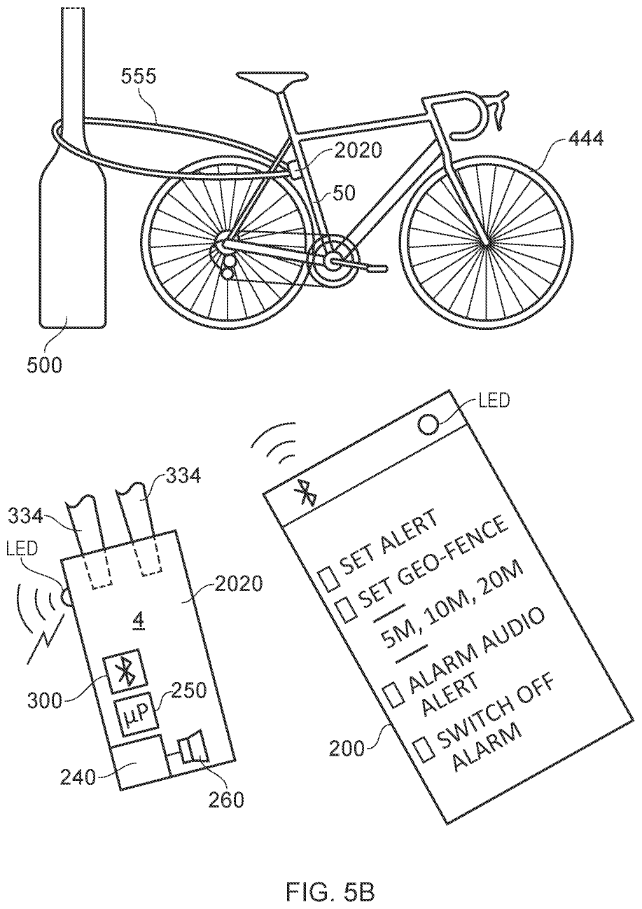

The housing 4 is locked to a cycle by a lockable clamp 3 that is formed integrally with the housing 4 and engages with one or more locks 1 to attach the housing 4 to the cycle. The housing 4 and lockable clamp 3 are shaped to receive a down tube portion of a bicycle frame, preferably the seat stay (shown in FIG. 5B).

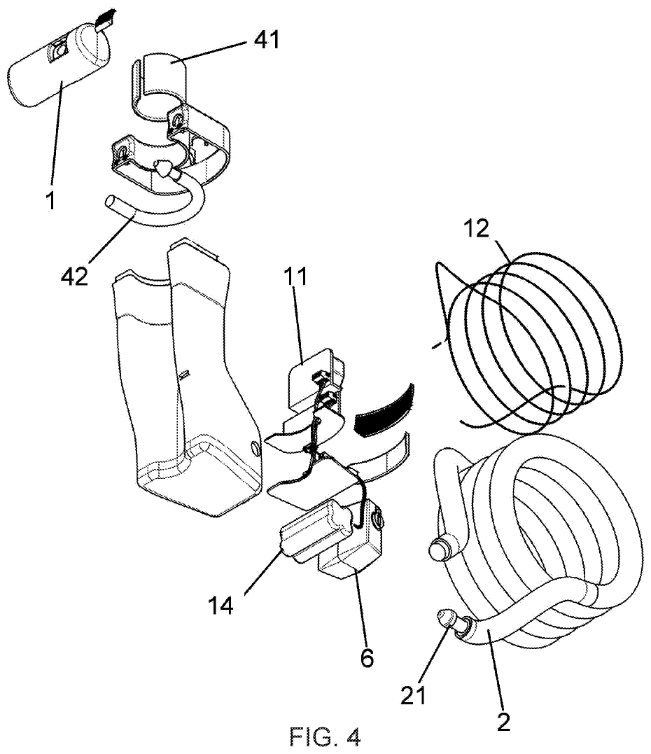

The tethering connector 2 has a first end 2A and a second end 2B (see FIG. 4). The first end 2A has a connector 21 that is received by lock 6. The second end of the tethering connector 2B is fixed to the lock 6 within the housing 4.

The tethering connector 2 has a conductive portion 12 so that when the two ends 2A, 2B are locked in the housing 4 in lock holes 5 that are in connection with the lock 6. A circuit is completed when both ends 2A, 2B of the tethering connector 2 are received in the lock holes 5. The circuit receives electric current from a source of electricity in the form of a battery 13.

A sensor (not shown) that is mounted on a printed circuit board (PCB) 14 and detects continuity of electric current in the circuit. An alert means is operative to trigger an alarm when an unauthorised break in continuity is detected. The alert means includes a light emitting diode (LED) 11 and a loudspeaker (not shown).

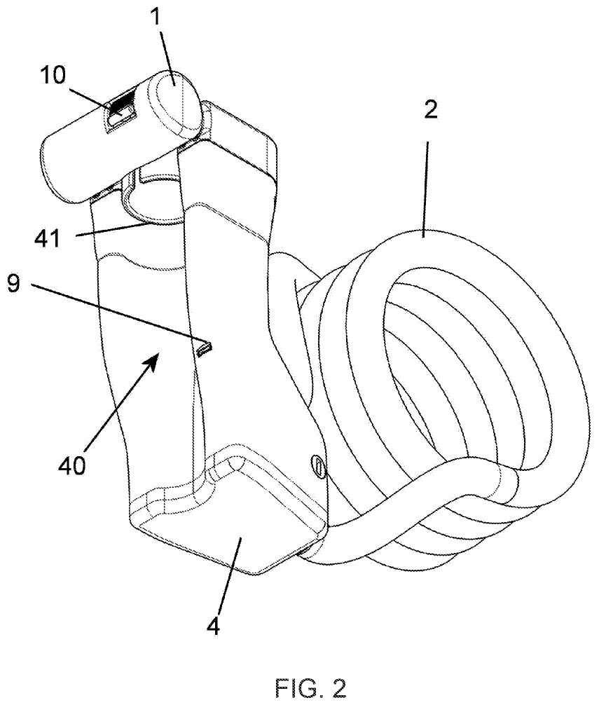

With particular reference to the embodiment in FIG. 2 there is shown an elongate tubular housing 4, with a clamp 3 at a first end on a first side which allows the housing 4 to wrap around a tube of the cycle. The tethering connector 2 is shown extending from the second, opposed side.

The housing 4 encases electronic sensors and components which are sealed in the housing to protect them from shock and prevent ingress of water which might damage them.

The electric lock 99 also includes a location means, in the form of a GPS tracker in addition to the alert means and this when configured under instruction of a microprocessor enables a user to establish a geo-fenced zone or region around the cycle.

The microprocessor is ideally also mounted on the PCB 14 and oversees and controls components of the electric lock 99 such as the GPS tracker, sensors and the LED 11 alert means.

The electric lock 99 has a receiver that enables it to be controlled remotely by a remote electronic device such as a smartphone or tablet.

The microprocessor is ideally operable in accordance with computer implemented software that is stored on and operates with the electronic device such as application specific software (APP) on a smartphone.

The LEDs 11 are arranged to illuminate from a panel on one second side of the housing so as to illuminate both the tethering connector 2 and an area away from the cycle.

The electric lock 99 may be provided with one or more rubber clamp inserts 41 to enable the housing 4 to clamp to a range of seats or cycle tube sizes, to prevent damage and to prevent slippage of the lock.

The lockable clamp 3 includes a U-shaped lock member 42 which clips into a seat provided in the housing 4. The U-shaped member 42 is received by the lock 1 so as to be fixed to the cycle. The U-shaped member and lock 1 can be separated by a key that is inserted into a keyhole 10 to rear of the housing 4.

The rear of the housing (first side) has a vertical channel 40 in which the down tube of the cycle sits and wherein the clamp insert 41 is located. In use the lock 1 and keyhole 10 are mounted on the opposed side of the down tube.

It is appreciated that the same key, or a different key, may operate each lock that secures ends of the tether or the lockable clamp 1 that clamps the housing 4 to the down tube and the lock mechanism 6 for securing the cycle to a structure.

For enhanced security, different keys, codes or other authentication may be used for each lock.

The conductive material in the connector is ideally an internal copper or steel element 12 that forms part of the continuity circuit. The sensor senses when the circuit is broken or is being tampered with. The conductive material is wrapped in a smooth non-conductive polyester material or sleeve. The, or each, end of the tethering connector 2 has a steel terminal 21 for engagement with the lock 6 which locks each end of the tethering connector to the housing 4.

Lockable fastening bolts or other connector retain the housing together. These are positioned so they are only accessible when not mounted on the cycle. In this way the housing cannot be removed by disassembling the housing.

Inside the housing has a rechargeable battery 13 that is preferably a lithium-Ion battery which may be charged via a micro USB port 9 on the rear (first side) of the housing 4.

A loudspeaker (not shown) is included in the housing to provide an audible alert means which would be able to sound an alarm if the circuit is broken whilst the electric lock is armed. It may be envisaged that this could also give other noise alerts such as when it becomes locked or unlocked.

In the pictured embodiment Red, Green, Blue (RGB) LEDs 11 are enclosed by a translucent panel 7 on the housing 4 and are arranged to flash when the lock 99 is tampered with. The microprocessor may be programmed so that the LEDs 11 give various visual cues.

In some embodiments the electric lock 99 forms part of an alarm system that includes a personal alarm which may be mounted on or carried by the user.

The personal alarm may have a plurality of buttons, to include having a button interface. Each button may have its own function. In use a user may press button, press and hold a button or press one or more buttons sequentially to perform different functions to include, but are not limited to: sending as signal to the electric lock to sound an alarm on the electric lock; sending a command signal to the electric lock to transmit its GPS location; and sending a signal that activates/deactivates the theft detection system on the lock.

One preferred method of operation of the alarm system is now described.

In use the user performs the following:
1—Secures the electric lock to the cycle by the lockable clamp, using an appropriate clamp seat tube insert and the lock.
2—Once at cycle parking location, deploys the tethering connector and wraps this around the cycle and an object in an effective manner.
3—Secures a free end of the tethering connector through a lock hole so that the free end engages with the lock within the housing to form a closed circuit which may be indicated by a visual and/or audible confirmation signal.
4—Logs into a smartphone APP and uses this to activate the electric lock in order to configure it into an armed status so that the alert means is active and so that an alert means is triggered if the circuit is broken.
5—When use of the cycle is required, the user disarms the lock either directly or by using the APP which then also disarms the alert means.
6—The tethering connector is then unlocked so that the cycle is able to be used.

Referring now to FIG. 5A which shows a diagrammatical overview of another embodiment of the bicycle lock 2020. The housing 2020 has recesses 210A and 210B each for receiving a connector (not shown) at each end of the tether. A lock 212 is depicted which engages with the ends in order to lock them to the housing 2020. Located in the recesses 210A and 210B are contacts 220 and 222 respectively. The contacts 220 and 222 are connected to a continuity sensor 230 and a battery 240. When both the connectors are inserted into the into the recesses 210A and 210B a circuit is made, as described above, which is sensed by the sensor 230 and communicated to a controller in microprocessor 250.

When the microprocessor 250 is switched to alert mode any disruption in current flowing in the continuity circuit is detected and a signal is sent to the microprocessor 250. Upon verifying that the disruption in current flow (or current level) occurs as a consequence of an attempt to steal the cycle, the microprocessor 250 sends an alert signal to one or more alert means which are then activated.

One of the alert means is an audio output device, such as loudspeaker 260. Another alert means is a light source, such as a light emitting diode or LED 270.

A further alert means is optionally relayed to a wireless transmitter 280 for transmission to a remote device, such as the aforementioned personal alarm or a mobile communication device, such as a smartphone (as shown in FIG. 5B).

FIG. 5B shows a diagrammatical overview of a system including a bicycle 444 with a lock housing 2020 fitted to its downtube 50. The bicycle 44 is tethered to a lamppost 500 by way of tether 555. In this embodiment two ends 333 and 334 of the tether 555 both are separate from the housing and are both locked therein by way of a secure connection.

A Bluetooth® transceiver 300 receives commands from microprocessor 250 or other device. Battery 24 is shown connected to audio device 260. A hand-held remote device 200 shows a display on which options are represented as a user defined menu. The handheld device 200 has a Bluetooth® transceiver to send and receive signals to/from the lock.

The invention has been described by way of examples only and it will be appreciated that variation may be made to the above-mentioned embodiments without departing from the scope of invention as defined by the claims.

1. An electric lock comprises
a housing with a lockable clamp that secures the housing to a frame of a cycle,
the housing receives and locks at least one of a first and a second end of a tethering connector, the tethering connector has a conductive portion so that when the two ends are locked with respect to the housing, a circuit is completed which receives electric current from a source;
a sensor detects continuity in the circuit; and
an alert means is operative under control of a processor to trigger an alarm when an unauthorised break of continuity is detected.

2. The electric lock according to claim 1 wherein the alert means is a visual alarm.

3. The electric lock according to claim 1 wherein the alert means is an audible alarm.

4. The electric lock according to claim 1 wherein the alert means is a haptic device.

5. The electric lock according to claim 1 includes a wireless communication means which is operative to transmit an alert signal to a remote receiver.

6. The electric lock according to claim 1 includes a geo-location means, such as a tracking device.

7. The electric lock according to claim 1 includes at least one imaging means that is initiated to capture images when an unauthorised break of continuity is detected.

8. The electric lock according to claim 1 includes an electronic memory to store data.

9. The electric lock according to claim 1 wherein the current source comprises at least one rechargeable battery.

10. The electric lock according to claim 1 wherein the electric lock includes a transmitter.

11. The electric lock according to claim 10 wherein the electric lock includes a wireless receiver.

12. A remote controller for use with the electric lock according to claim 1.

13. The remote controller according to claim 12 includes a means for attaching the remote controller to a user.

14. The remote controller according to claim 12 includes a button that issues a notification to at last one remote device when pressed.

15. A system includes an electric lock according to claim 1 and a remote controller for use with the electric lock, wherein the remote controller is operative to transmit a signal to the receiver in the lock in order to configure the lock to a user defined status.

16. The system according to claim 15 includes a GPS device which when configured establishes a geo-fenced zone around the location of the lock and an alarm is triggered when the lock is moved outside the geo-fenced region.

17. The system according to claim 15 includes a mobile communication device, such as mobile telephone, tablet or laptop, which is operated in accordance with computer implemented software.

18. The system according to claim 15 includes a personal alarm or security module which is operated in accordance with computer implemented software.
